(19) United States
(12) Patent Application Publication
(10) Pub. No.: US 2012/0051032 A1
(43) Pub. Date: Mar. 1, 2012

(54) LIGHT EMISSION ANGLE ADJUSTING SHEET, DISPLAY PANEL, DISPLAY DEVICE, AND METHOD FOR MANUFACTURING LIGHT EMISSION ANGLE ADJUSTING SHEET

(76) Inventors: Iori Aoyama, Osaka (JP); Akihiro Yamamoto, Osaka (JP)

(21) Appl. No.: 13/319,370

(22) PCT Filed: Feb. 22, 2010
(86) PCT No.: PCT/JP2010/052603

§ 371 Date: Nov. 8, 2011

(30) Foreign Application Priority Data
Jun. 4, 2009 (JP) 2009-134651

(51) Int. Cl. G09F 13/04; C25D 11/02; F21V 5/00

(52) U.S. Cl. 362/97.2; 362/330; 205/333

(57) ABSTRACT

A plurality of low refractive index material-exposed portions (23) having the same area and a plurality of high refractive index material-exposed portions (22) having different areas are mixed and arranged on an emission surface (11U) of a light emission angle adjusting sheet (11). In particular, a low refractive index material (13) has a shape having a width which monotonically decreases toward a light receiving surface (11B) side.

### TECHNICAL FIELD

The present invention relates to a light emission angle adjusting sheet that diffuses and lets out the light it has received, a display panel fitted with such a light emission angle adjusting sheet, and a display device. The present invention also relates to a method of manufacturing a light emission angle adjusting sheet.

### BACKGROUND ART

Generally, when a viewer views a liquid crystal display device (display device) incorporating a display panel such as a liquid crystal display panel, he may view the image on it from different directions oblique to the liquid crystal display panel.

A light emission angle adjusting sheet is an optical member whereby light from a backlight unit which is incident on a liquid crystal display panel approximately perpendicularly to it is diffused in all directions after emerging from the liquid crystal display panel.

To be sure, a liquid crystal display panel is designed to optically compensate for the difference of how the light emerging obliquely from the panel surface is perceived from how the light emerging perpendicularly from the panel surface. However, a perfect compensation is difficult to attain. In a liquid crystal display panel of the vertical alignment (VA) type, while the contrast ratio characteristics are superb in frontal viewing, the contrast ratio varies more greatly in oblique viewing than in frontal viewing (the viewer's impression varies more greatly (he perceives a greater change) between when he views the liquid crystal display panel from right in front and when he views it from oblique directions).

That is, liquid crystal display devices suffer from the problem of what is displayed on them appearing differently from different directions, that is, the problem of poor viewing angle characteristics. One way to solve this problem is to shield the backlight that is incident on the liquid crystal display panel obliquely, but this makes it impossible to view the image from oblique directions.

To solve the problem, a light emission angle adjusting sheet is included in a liquid crystal display panel. The light emission angle adjusting sheet directs light obliquely with respect to the liquid crystal display panel, and thereby makes it easier for the viewer to view the image (for example, Patent Document 1 listed below). This makes approximately the same the image viewed from straight in front of the liquid crystal display panel and the image viewed from directions oblique to the liquid crystal display panel; thus, the image no longer varies with viewing angle, and a so-called viewing-angle-free liquid crystal display device is obtained.

### LIST OF CITATIONS

### Patent Literature

Patent Document 1: JP-A-2007-148185

### SUMMARY OF INVENTION

### Technical Problem

However, in the light emission angle adjusting sheet disclosed in Patent Document 1, as shown in a sectional view in FIG. 21, the low-refractive-index material 113 in the light emission angle adjusting sheet 111 has a wedge-shaped section. In a case where such a low-refractive-index material 113 is embedded in a high-refractive-index material 112, the high-refractive-index material 12 requires a die or the like that reflects the shape of the low-refractive-index material 113. A die with such a special shape is expensive, and making a die reflect a special shape is itself difficult.

The present invention has been devised to solve the above problems. It is an object of the present invention to provide a light emission angle adjusting sheet etc. that are easy and inexpensive to manufacture but nevertheless help improve the viewing angle characteristics of display devices.

### Solution to Problem

A light emission angle adjusting sheet comprises a light-input surface and a light-output surface through which light having passed through the light-input surface is let out. The light emission angle adjusting sheet comprises a low-refractive-index material and a high-refractive-index material having different refractive indices. On the light-output surface, there are spread a plurality of low-refractive-index material exposed portions, where the low-refractive-index material is exposed, and a plurality of high-refractive-index material exposed portions, where the high-refractive-index material is exposed. The plurality of low-refractive-index material exposed portions, which have the same area, and the plurality of high-refractive-index material exposed portions, which have different areas, are arranged in a mixed fashion. The low-refractive-index material has a shape that monotonically narrows toward the light-input surface.

With this structure, the light emission angle adjusting sheet includes, for example, a region where a low-refractive-index material exposed portion and a high-refractive-index material exposed portion having a first area are arranged and a region where a low-refractive-index material exposed portion and a high-refractive-index material exposed portion having a second area (different from the first area) are arranged. This light emission angle adjusting sheet, compared with one which only includes, for example, a region where a low-refractive-index material exposed portion and a high-refractive-index material exposed portion having a first area are arranged, permits easier adjustment of light intensity balance among different angles of emergence of light. This makes it easier for the light emerging from the light emission angle adjusting sheet to diffuse in different directions (provides improved luminance diffusion).

Moreover, the low-refractive-index material has a monotonically narrowing shape. Thus, a cutting tool for processing a die can be produced easily, and the processing of the die does not require excessively high precision. The above light emission angle adjusting sheet can therefore be manufactured more easily than one comprising a low-refractive-index material having a complicated shape.

That is, the light emission angle adjusting sheet can be manufactured inexpensively and easily. Thus, the light emission angle adjusting sheet can be manufactured easily and inexpensively, and in addition improves the viewing angle characteristics of display devices.

One example of a monotonically narrowing shape for the low-refractive-index material is one defining an isosceles triangle on a cross section. More specifically, the low-refractive-index material is triangular-prism-shaped, with one angle of the triangular shape pointing to the light-input surface and the other two angles pointing to the light-output surface, and defines, on a cross section crossing the prism axis direction, an isosceles triangle having the light-input surface-side one angle as a vertical angle and the other two angles as base angles.

Preferably, the low-refractive-index material exposed portions and the high-refractive-index material exposed portions are arranged alternately, there are two or more different areas that the high-refractive-index material exposed portions have, and within the row of the high-refractive-index material exposed portions, high-refractive-index material exposed portions having different areas are arranged alternately.

With this structure, the distribution of the high-refractive-index material exposed portions in the light emission angle adjusting sheet is even across the plane, and thus the luminance diffusion of the entire light emission angle adjusting sheet is even across the plane. This surely improves the viewing angle characteristics of a liquid crystal display device incorporating the light emission angle adjusting sheet.

The low-refractive-index material may comprise a transparent resin or a transparent resin containing a light-absorbing material. This increases flexibility in the choice of the material.

The light emission angle adjusting sheet may have a single-layer or multiple-layer structure. For example, in a light emission angle adjusting sheet having a two-layer structure, it is preferable that the extension direction of the low-refractive-index material exposed portions in the first layer and the extension direction of the low-refractive-index material exposed portions in the second layer cross each other.

With this structure, the light emerging from the light emission angle adjusting sheet is diffused in two directions, namely in the arrangement direction of the low-refractive-index material in the light emission angle adjusting sheet 1 in the first layer and in the arrangement direction of the low-refractive-index material in the light emission angle adjusting sheet in the second layer. Thus, the luminance distribution characteristics of the light emerging from the light emission angle adjusting sheet are improved in two directions that cross each other.

The light-output surface may be laid with a surface treatment film. This structure helps reduce reflection of sunlight or the like on the light emission angle adjusting sheet.

Display panels having a light emission angle adjusting sheet as described above fitted on the display surface are within the scope of the present invention. Also, display devices comprising such a display panel and an illuminating device supplying light to the display panel are within the scope of the present invention.

When such a display device is installed, the reference position of the display panel is determined with respect to the horizontal direction. In a case where, on the surface of the display panel arranged in the reference position, a first reference direction is defined to run in the same direction as the horizontal direction and a second reference direction is defined to cross the first reference direction, it is preferable that the low-refractive-index material exposed portions be linear, and that the direction in which they are linear coincide with the first or second reference direction. The reason is that the desired luminance diffusion direction varies with the position from which a viewer views the liquid crystal display device.

### Advantageous Effects of the Invention

Light emission angle adjusting sheets according to the present invention can be manufactured easily and inexpensively, and improve the viewing angle characteristics of display devices.

### BRIEF DESCRIPTION OF DRAWINGS

FIG. 1 is an exploded perspective view showing, on an enlarged scale, a liquid crystal display panel;

FIG. 2 is a sectional view of a light emission angle adjusting sheet (taken along line A-A′ in FIG. 1);

FIG. 3 is an exploded sectional view of a light emission angle adjusting sheet;

FIG. 4 comprises a plan view and a sectional view, presented together, of a light emission angle adjusting sheet;

FIG. 5 is a graph showing the luminance diffusion characteristics (viewing angle characteristics) of a light emission angle adjusting sheet;

FIG. 6 is a graph showing the luminance diffusion characteristics (viewing angle characteristics) of a light emission angle adjusting sheet;

FIG. 7 is a graph of normalized luminance against gradation for light from a light emission angle adjusting sheet;

FIG. 8 is a graph of normalized luminance against gradation for light from a light emission angle adjusting sheet;

FIG. 9 comprises a plan view and a sectional view, presented together, of a light emission angle adjusting sheet of a comparative example;

FIG. 10 is a graph showing the luminance diffusion characteristics (viewing angle characteristics) of a light emission angle adjusting sheet of a comparative example;

FIG. 11 is a graph showing the luminance diffusion characteristics (viewing angle characteristics) of a light emission angle adjusting sheet of a comparative example;

FIG. 12 is a graph of normalized luminance against gradation for light from a light emission angle adjusting sheet of a comparative example (with an aperture ratio HLf of 50%);

FIG. 13 is a graph of normalized luminance against gradation for light from a light emission angle adjusting sheet of a comparative example (with an aperture ratio HLf of 60%);

FIG. 14 is a graph of normalized luminance against gradation for light from a light emission angle adjusting sheet of a comparative example (one fitted on MVA liquid crystal);

FIG. 15 is a graph of normalized luminance against gradation for light from a light emission angle adjusting sheet of a comparative example (with an aperture ratio HLf of 50%);

FIG. 16 is a graph of normalized luminance against gradation for light from a light emission angle adjusting sheet of a comparative example (with an aperture ratio HLf of 60%);

FIG. 17 is an exploded perspective view showing, on an enlarged scale, a liquid crystal display panel;

FIG. 18 is a diagram illustrating the positional relationship between a liquid crystal television incorporating a liquid crystal display device and a viewer;

FIG. 19 is a diagram illustrating the positional relationship between a display for digital signage and a viewer;

FIG. 20 is an exploded perspective view of a liquid crystal display device; and

FIG. 21 is a sectional view of a conventional light emission angle adjusting sheet.

### DESCRIPTION OF EMBODIMENTS

### Embodiment 1

An embodiment of the invention will be described below with reference to the accompanying drawings. For convenience' sake, hatching, reference signs, etc. are occasionally omitted, in which case any relevant drawing is to be referred to. Conversely, again for convenience' sake, hatching is occasionally used in a drawing other than a sectional view. A black dot indicated along with arrows represents the direction perpendicular to the plane of the page.

Although the following description discusses, as an example of a display device, a liquid crystal display device of the MVA (multidomain vertical alignment) type, this is in no way meant to limit the invention.

FIG. 20 is an exploded perspective view of a liquid crystal display device 59. As shown there, the liquid crystal display device 59 includes a liquid crystal display panel 39, a backlight unit (illuminating device) 49 which supplies light to the liquid crystal display panel 39, and a housing HG (a front housing HG1 and a rear housing HG2) in which those components are housed.

The liquid crystal display panel 39 has an active matrix substrate 31, which includes switching devices such as TFTs (thin-film transistors), and a counter substrate 32, which lies opposite the active matrix substrate 31, bonded together with a sealing member (unillustrated). The gap between the two substrates 31 and 32 is filled with liquid crystal (unillustrated).

The counter substrate 32 is fitted with a light emission angle adjusting sheet 11. The light emission angle adjusting sheet 11 is an optical member which receives light emerging from the counter substrate 32 and adjusts the angle of emergence of the received light. The incorporation of this light emission angle adjusting sheet 11 in the liquid crystal display panel (and hence the liquid crystal display device 59) permits the viewing angle of the liquid crystal display panel 39 to be adjusted (the details will be given later).

The active matrix substrate 31 is, on its light-input surface, fitted with a polarizing film 33, and the counter substrate 32 is, on its light-output surface, fitted with a polarizing film 33. The light emission angle adjusting sheet 11 is fitted on the polarizing film 33 on the counter substrate 32. The liquid crystal display panel 39 structured as described above displays an image by exploiting variation in transmittance ascribable to inclination of liquid crystal molecules.

Next, the backlight unit 49 will be described. The backlight unit 49 includes an unillustrated light source and a stack of optical sheets (light-condensing member) 41 for condensing the light from the light source. The light source comprises, for example, a fluorescent tube or an LED (light-emitting diode), and is subject to no limitation so long as it emits light. The stack of optical sheets 41 has, for example, one diffusive sheet and two lens sheets stacked together, and makes the light from the light source even while condensing it (in a case where the light source is one that can condense light before it enters the stack of optical sheets 41, the stack of optical sheets 41 may be omitted).

The backlight unit 49 described above is provided directly under the active matrix substrate 31 of the liquid crystal display panel 39, and shines light on the liquid crystal display panel 39, which is a non-luminous liquid crystal display panel. Thus, by receiving light (backlight) from the backlight unit 49, the liquid crystal display panel 39 improves its display function. Shining the light from the backlight unit 49 on the entire surface of the liquid crystal display panel 39 evenly helps improve the display quality of the liquid crystal display panel 39.

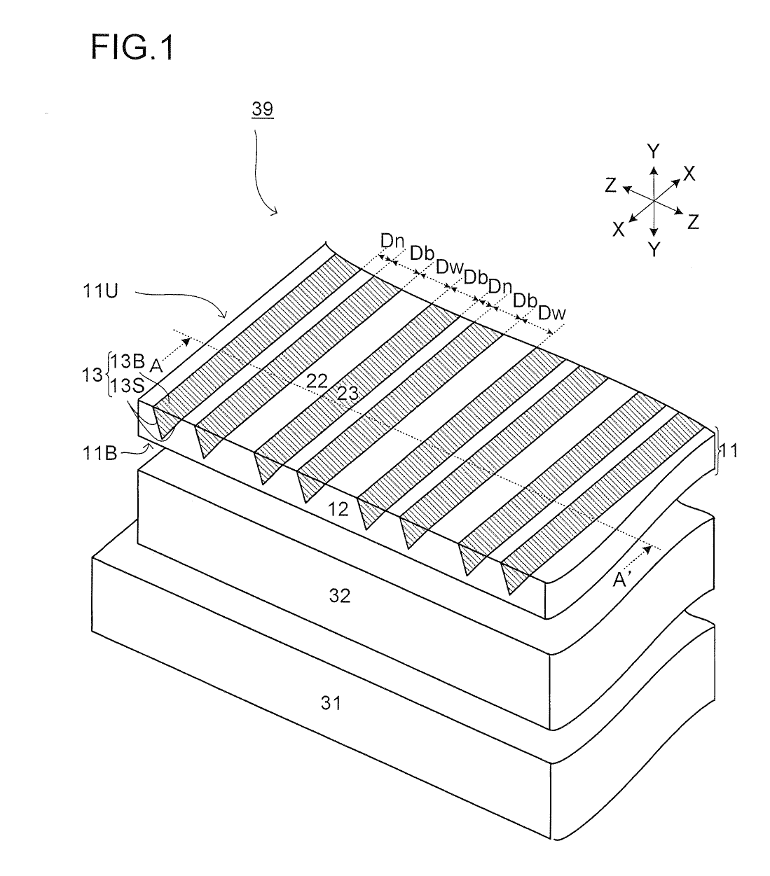

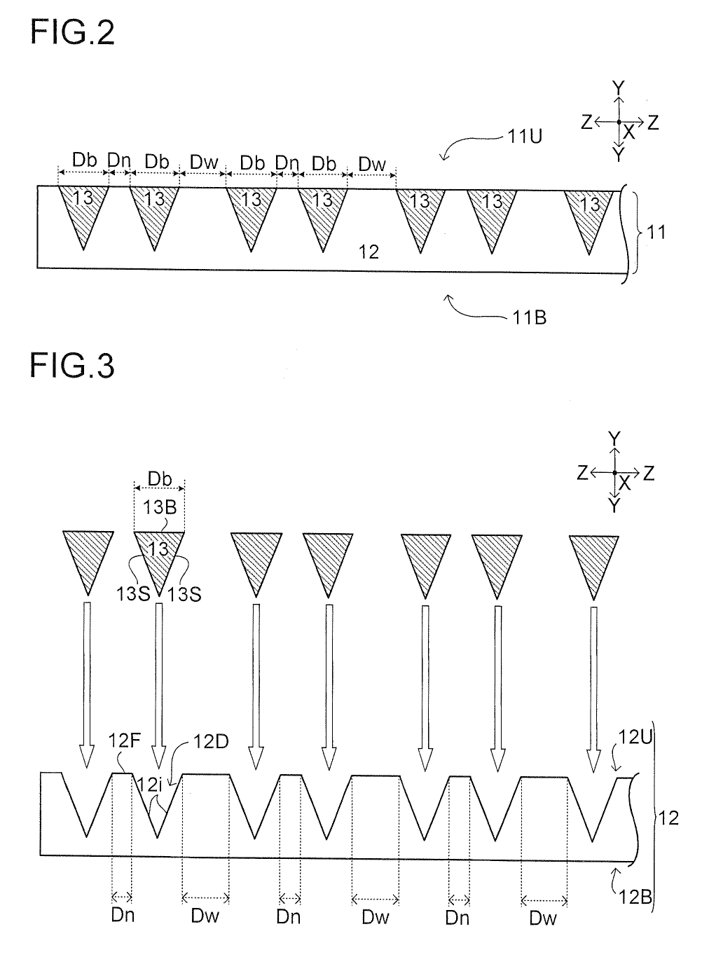

Now, the light emission angle adjusting sheet 11 included in the liquid crystal display panel 39 will be described in more detail with reference to FIGS. 1 to 3. FIG. 1 is an exploded perspective view showing, on an enlarged scale, the liquid crystal display panel 39 (with the polarizing film 33 omitted for convenience' sake). FIG. 2 is a sectional view of the light emission angle adjusting sheet 11 (taken along line A-A′ in FIG. 1). FIG. 3 is an exploded sectional view of the light emission angle adjusting sheet 11.

As shown in FIG. 1, the light emission angle adjusting sheet 11 has a light-input surface 11B through which it receives light traveling from the counter substrate 32 and a light-output surface 11U through which it lets out the light having passed through the light-input surface 11B. Moreover, the light emission angle adjusting sheet 11 includes a plurality of materials with different refractive indices. More specifically, the light emission angle adjusting sheet 11 includes a material with a comparatively high refractive index (high-refractive-index material) 12, such as polycarbonate or epoxy acrylate, and a material with a comparatively low refractive index (low-refractive-index material) 13, such as polymethyl methacrylate, urethane acrylate, or a fluoropolymer.

As shown in FIGS. 1 and 2, the high-refractive-index material 12 serves as the substrate (base) of the light emission angle adjusting sheet 11, and the low-refractive-index material 13 is embedded in the high-refractive-index material 12. More specifically, as shown in FIG. 3, the high-refractive-index material 12 is a planar member having, on one side, a flat surface 12B serving as the light-input surface 11B and, on the opposite side, an irregular (non-flat) surface 12U in which linear troughs are arranged (the irregular surface 12U serving as part of the light-output surface 11U).

The irregular surface 12U includes flat portions 12F having the same plane direction as the flat surface 12B and trough portions 12D depressed relative to the flat portions 12F. As shown in FIG. 3, the trough portions 12D are linear on the plane of the irregular surface 12U, and narrow toward the flat surface 12B (the direction in which the trough portions 12D extend (the extension direction) is taken as the X direction, the direction which crosses the X direction and in which the trough portions 12D sink is taken as the Y direction, and the direction which crosses both the X and Y directions is taken as the Z direction).

In one example, the trough portions 12D have a triangular cross section (for example, an isosceles triangular cross section) such that linear inner walls 12i of the trough portions 12D come close together toward the flat surface 12B to eventually meet.

A plurality of such trough portions 12D are arranged, for example, in a direction (such as the Z direction) crossing, such as perpendicular to, the direction in which they extend. The intervals D between the trough portions 12D, however, are not even. For example, as shown in FIG. 3, comparatively short intervals Dn and comparatively long intervals Dw occur alternately (Dn<Dw).

The trough portions 12D are buried (filled) with the low-refractive-index material 13. Thus, the low-refractive-index material 13 reflects the shape of the trough portions 12D; that is, the low-refractive-index material 13 is linear, and have a shape that monotonically narrows toward the flat surface 12B of the high-refractive-index material 12 (that is, the light-input surface 11B of the light emission angle adjusting sheet 11).

For example, as shown in FIGS. 1 to 3, the low-refractive-index material 13 is triangular-prism-shaped, with its base surface 13B facing the irregular surface 12U of the high-refractive-index material 12 (that is, the light-output surface 11U of the light emission angle adjusting sheet 11) and its side surfaces 13S and 13S facing the flat surface 12B of the high-refractive-index material 12 (that is, the light-input surface 11B of the light emission angle adjusting sheet 11).

When, on a section of the low-refractive-index material 13 crossing the prism axis direction (for example, the X direction) of its triangular prism shape, the part of the low-refractive-index material 13 exposed on the irregular surface 12U is taken as the base surface 13B and the parts lying in contact with the inner walls 12i of the trough portions 12D are taken as the side surfaces 13S and 13S, then the low-refractive-index material 13 can be considered to have a triangular (for example, isosceles triangular) cross section. In other words, the low-refractive-index material 13 is triangular-prism-shaped, with one angle of the triangular shape pointing to the light-input surface 11B and the other two angles pointing to the light-output surface 11U, and defines, on a cross section crossing the prism axis direction, an isosceles triangle having the light-input surface 11B-side one angle as a vertical angle and the other two angles as base angles.

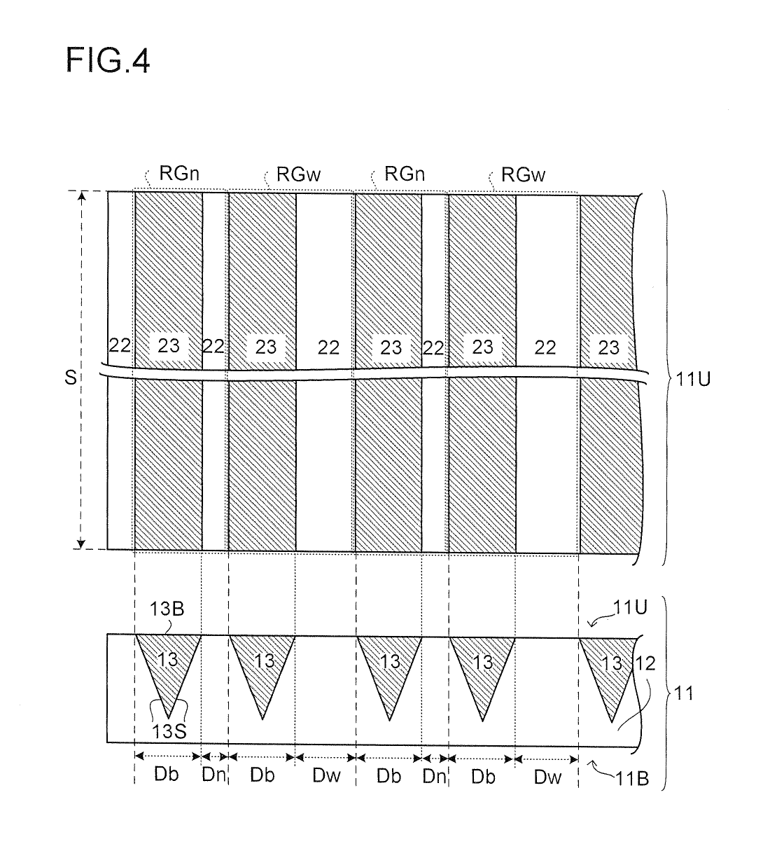

The light emission angle adjusting sheet 11 thus including the low-refractive-index material 13 and the high-refractive-index material 12 diffuses the light traveling from the backlight unit 49 and passing through the liquid crystal display panel 39. Now, the luminance diffusion characteristics of the light emission angle adjusting sheet 11 will be described in comparison with comparative examples. The following description refers, additionally, to FIGS. 4 to 16.

In the drawings, a value accompanied by a percent sign (%) is an aperture ratio HL. The aperture ratio HL is defined in terms of, as shown in FIG. 4 (comprising a plan view and a sectional view presented together), the area of the part of the low-refractive-index material 13 exposed on the light-output surface 11U of the light emission angle adjusting sheet 11 and the area of the part of the high-refractive-index material 12 exposed on the light-output surface 11U.

More specifically, on the light-output surface 11U of the light emission angle adjusting sheet 11, let a portion of the low-refractive-index material 13 exposed there be referred to as a low-refractive-index material exposed portion 23 (that is, the base surface 13B of the low-refractive-index material 13), and let a portion of the high-refractive-index material 12 exposed there be referred to as a high-refractive-index material exposed portion 22. Then, the low-refractive-index material exposed portion 23 and the high-refractive-index material exposed portion 22 are each planar and have a certain area.

Consider a pair of mutually adjacent low- and high-refractive-index material exposed portions 23 and 22, and define the aperture ratio HR (%) as the ratio of their areas on the light-output surface 11U. Specifically, it is defined as follows.

HR=AR[H]/(AR[H]+AR[L])×100 Formula (A1)

where
AR[H] represents the area of the high-refractive-index material exposed portion 22;
AR[L] represents the area of the low-refractive-index material exposed portion 23; and
HR represents, in the pair of mutually adjacent low- and high-refractive-index material exposed portions 23 and 22, the proportion of the area of the high-refractive-index material exposed portion 22 in the sum of the areas of the high- and low-refractive-index material exposed portions 22 and 23.

Let the length of the low-refractive-index material exposed portion 23 along its extension direction be represented by “S” and let the width of the low-refractive-index material exposed portion 23 be represented by “Db”. Then AR[L] is given by “S×Db”. The area AR[H] of the high-refractive-index material exposed portion 22 is calculated from “S”, which also represents the length of one side of the light emission angle adjusting sheet 11, and the interval Dn or Dw between the trough portions 12D. Specifically, the area AR[H] equals “S×Dn” or “S×Dw”.

Then, since different high-refractive-index material exposed portions 22 have varying areas AR[H], the light emission angle adjusting sheet 11 has varying aperture ratios HL on the light-output surface 11U. Specifically, the aperture ratio HL equals either an aperture ratio HLn or an aperture ratio HLw as given below.

HLn=(S×Db)/[(S×Db)+(S×Dn)]×100 Formula (A2)

HLw=(S×Db)/[(S×Db)+(S×Dw)]×100 Formula (A3)

Moreover, in a case where, as shown in FIG. 4, on the light-output surface 11U, low- and high-refractive-index material exposed portions 23 and 22 are arranged alternately, and in addition, within the row, included in the overall row, of the high-refractive-index material exposed portions 22, those having different areas “S×Dn” and “S×Dw” are arranged alternately, then regions RGn with an aperture ratio HLn and regions RGw with an aperture ratio HLw are arranged alternately on the light-output surface 11U (in FIG. 4, for convenience' sake, the segments indicated by dotted lines in illustration of regions RG are shown with no overlaps among them).

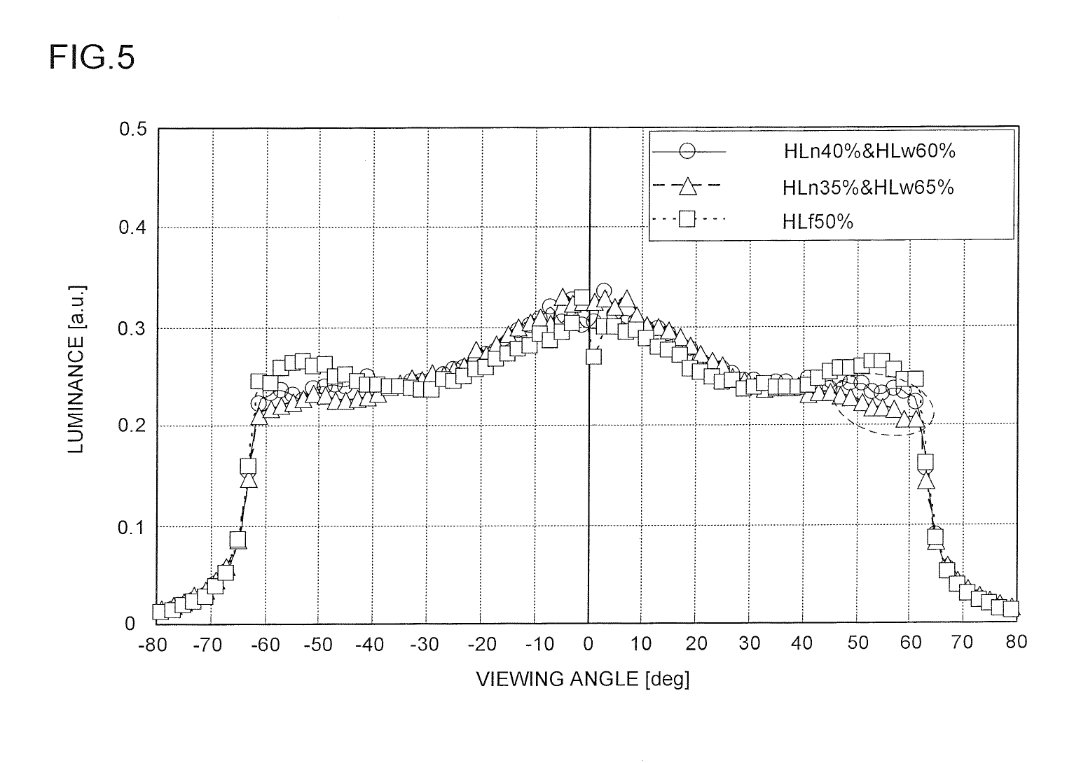

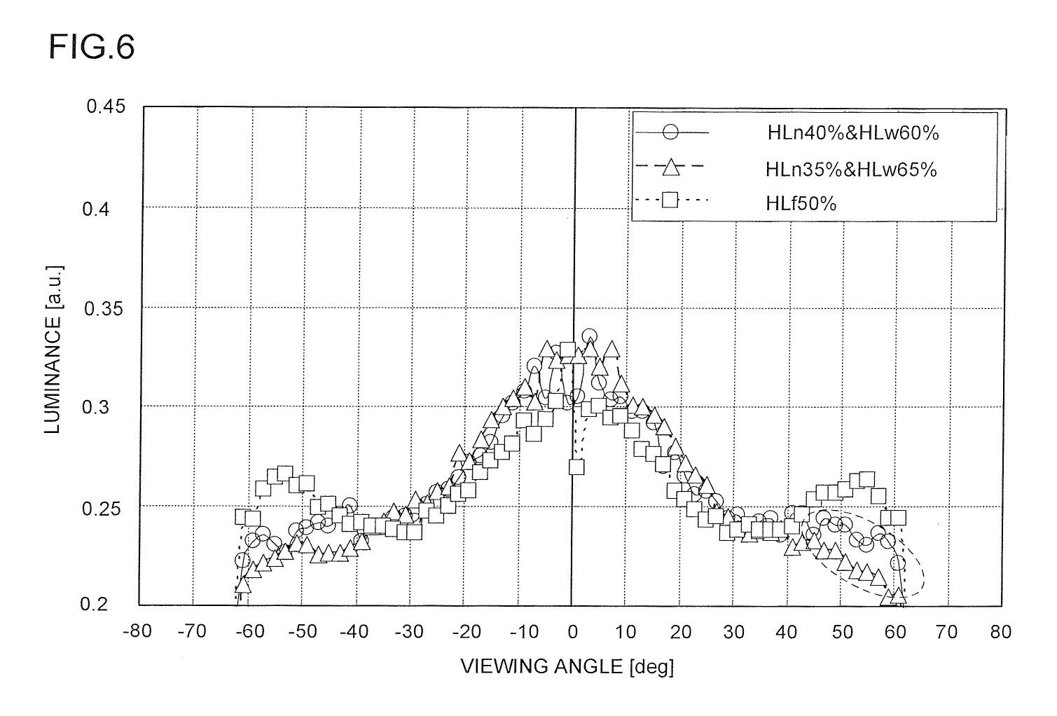

A light emission angle adjusting sheet 11 in which regions RGn with an aperture ratio HLn of 40% and regions RGw with an aperture ratio HLw of 60% are arranged alternately, and a light emission angle adjusting sheet 11 in which regions RGn with an aperture ratio HLn of 35% and regions RGw with an aperture ratio HLw of 65% are arranged alternately, have luminance diffusion characteristics as shown in graphs in FIGS. 5 and 6 (for easy understanding, a characteristics curve for an aperture ratio HLf of 50%, which will be discussed later, is shown together). In these graphs, the vertical axis represents luminance (a.u.—arbitrary unit), and the horizontal axis represents the angle of emergence (degrees) of the light emergent from the light emission angle adjusting sheet 11. FIGS. 5 and 6 differ in the range of luminance taken along the vertical axis.

Unlike the light emission angle adjusting sheet 11 shown in FIG. 4, light emission angle adjusting sheets 11 of comparative examples have a single aperture ratio HL on the light-output surface 11U of the light emission angle adjusting sheet 11.

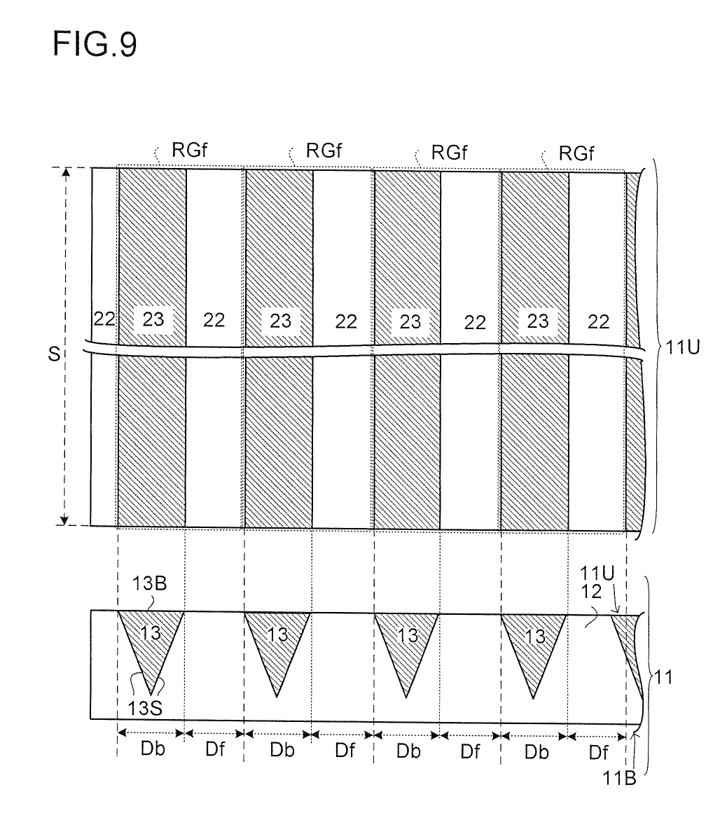

Specifically, as shown in FIG. 9, the high-refractive-index material exposed portions 22 have even widths (Df) as do the low-refractive-index material exposed portions 23. Thus, specifically, the aperture ratio HL equals an aperture ratio HLf given as follows:

HLf=(S×Db)/[(S×Db)+(S×Df)]×100 Formula (A4)

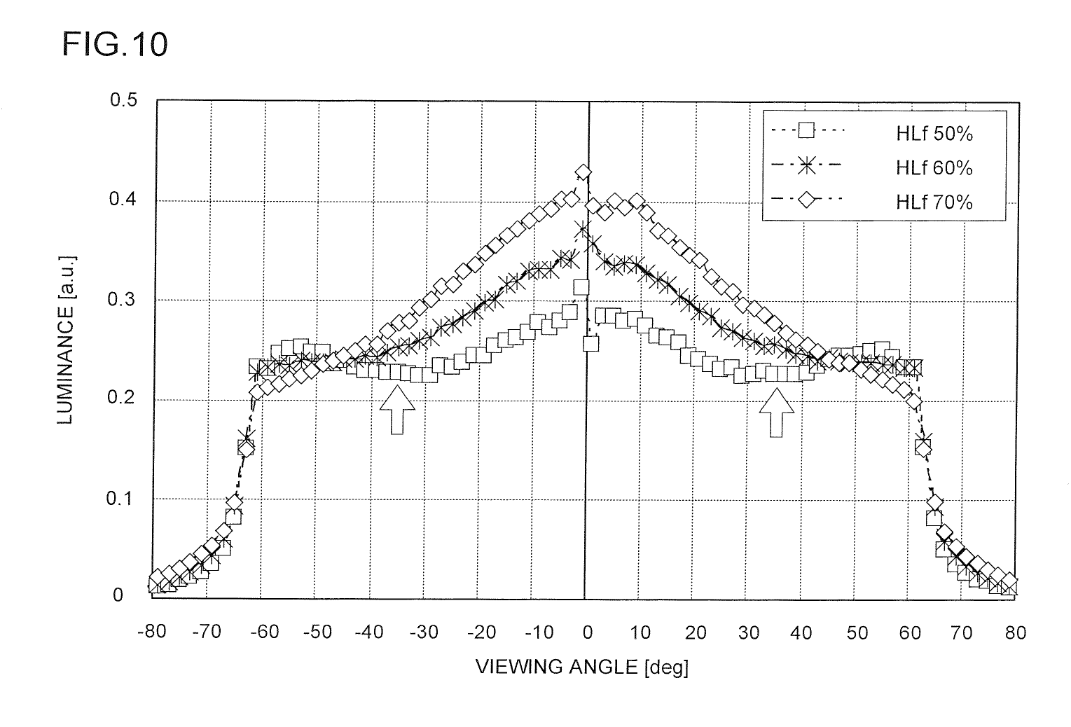

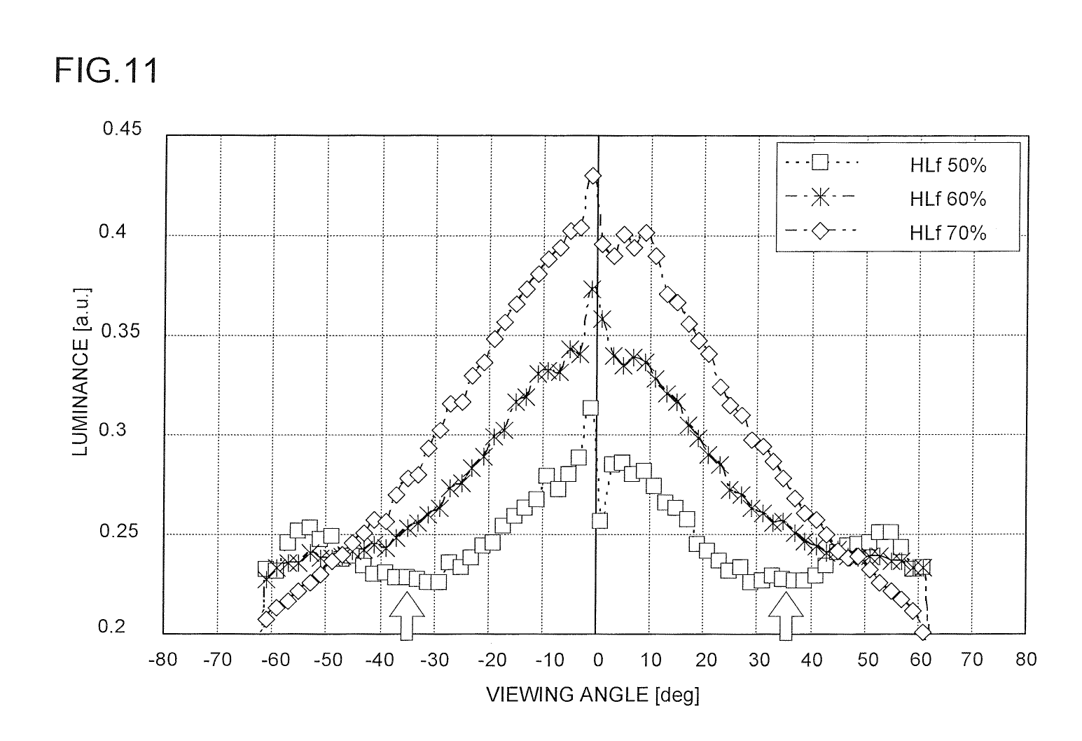

A light emission angle adjusting sheet 11 in which regions RGf with an aperture ratio of 50% are arranged, a light emission angle adjusting sheet 11 in which regions RGf with an aperture ratio of 60% are arranged, and a light emission angle adjusting sheet 11 in which regions RGf with an aperture ratio of 70% are arranged, have luminance diffusion characteristics as shown in graphs in FIGS. 10 and 11 (FIG. 10 corresponding to FIG. 5, and FIG. 11 corresponding to FIG. 6).

First, the comparative examples will be described. Typical luminance distribution characteristics describe a mountain-shaped curve, to provide high luminance in frontal viewing, such that luminance is highest around a viewing angle of 0 (°) (luminance in frontal viewing) and decreases the larger the angle therefrom (from a viewing angle of 0 (°)). In oblique viewing, however, while the luminance of the image signal is lower, the reflection of outside light on the surface increases, making the viewing difficult. Thus, it is preferable that, within a wide range of viewing angles, a certain degree of luminance is maintained compared with luminance in frontal viewing. Such preferred luminance describes, in the graphs in FIGS. 10 and 11, a characteristics curve that runs as parallel as possible to the horizontal axis. The description now continues with reference to FIGS. 10 and 11.

With an aperture ratio HLf of 50%, luminance is at its maximum around a viewing angle of 0 (°), and gradually decreases from the maximum as the viewing angle increases in the range of viewing angles from 0 (°) to |40 (°)|. Here, however, the characteristics curve in the range of viewing angles from 0 (°) to |40 (°)| does not have an excessively large inclination angle relative to the horizontal axis (that is, the characteristics curve can be said to be comparatively parallel to the horizontal axis).

By contrast, luminance around a viewing angle of |50 (°)| is higher than luminance around a viewing angle of |40 (°)|. Accordingly, the characteristics curve in the range of viewing angles from 0 (°) to |60 (°)|, though comparatively parallel to the horizontal axis, has dips (indicated by white arrows). With such dips occurring, in the image on the liquid crystal display panel 39, a line darker than elsewhere (a dark line) is visible, leading to poorer image quality.

From the viewpoint of eliminating such a dark line, a light emission angle adjusting sheet 11 with an aperture ratio HLf of 60% or 70% is preferable. The reason is as follows: as shown in FIGS. 10 and 11, the maximum luminance around a viewing angle of 0 (°) with an aperture ratio HLf of 60% or 70% is higher than the maximum luminance around a viewing angle of 0 (°) with an aperture ratio HLf of 50%; thus, the characteristics curve in the range of viewing angles from 0 (°) to |40 (°)| has a comparatively large angle relative to the horizontal axis, and this reduces the difference between luminance around a viewing angle of |50 (°)| and luminance around a viewing angle of |40 (°)|.

With an aperture ratio HLf of 60% or 70%, however, since the maximum luminance around a viewing angle of 0 (°) is higher than with an aperture ratio HLf of 50%, the characteristics curve with an aperture ratio HLf of 60% or 70% is less parallel to the horizontal axis than the characteristics curve with an aperture ratio of 50%, indicating insufficient luminance diffusion.

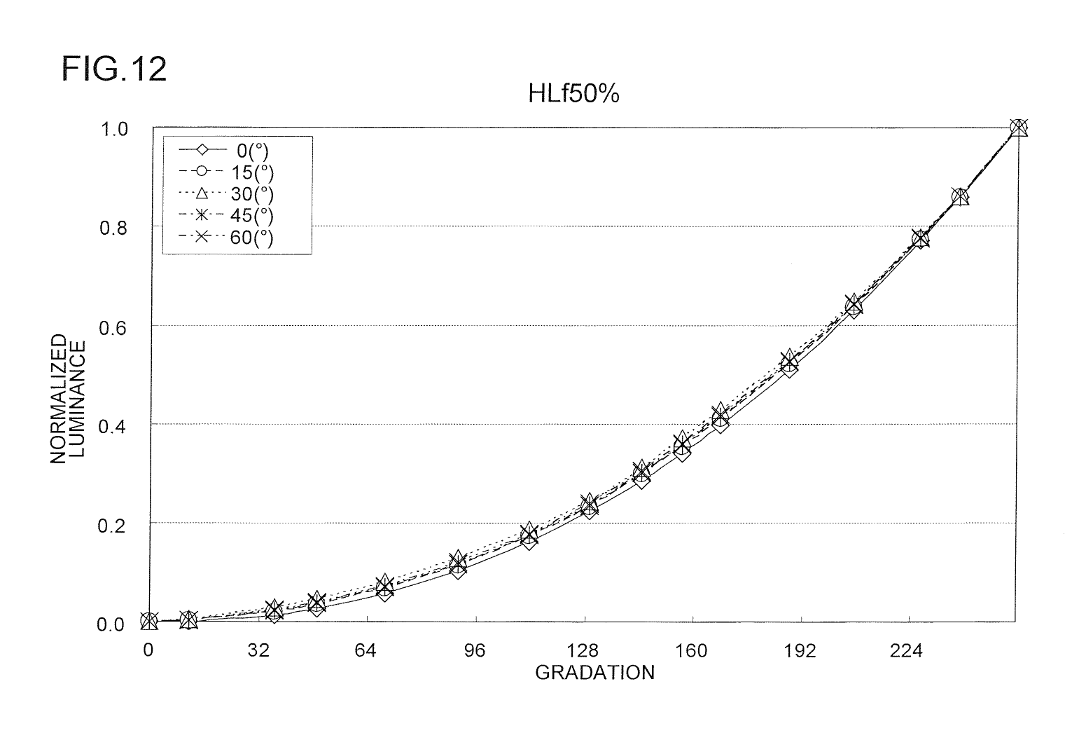

A comparison of a liquid crystal display panel 39 fitted with a light emission angle adjusting sheet 11 with an aperture ratio HLf of 50%, a liquid crystal display panel 39 fitted with a light emission angle adjusting sheet 11 with an aperture ratio HLf of 60%, and a liquid crystal display panel having MVA liquid crystal in a graph where the vertical axis represents normalized luminance (luminance normalized such that the maximum luminance equals 1.0) and the horizontal axis represents gradation (0 to 255) reveals the following (see FIGS. 12 to 14).

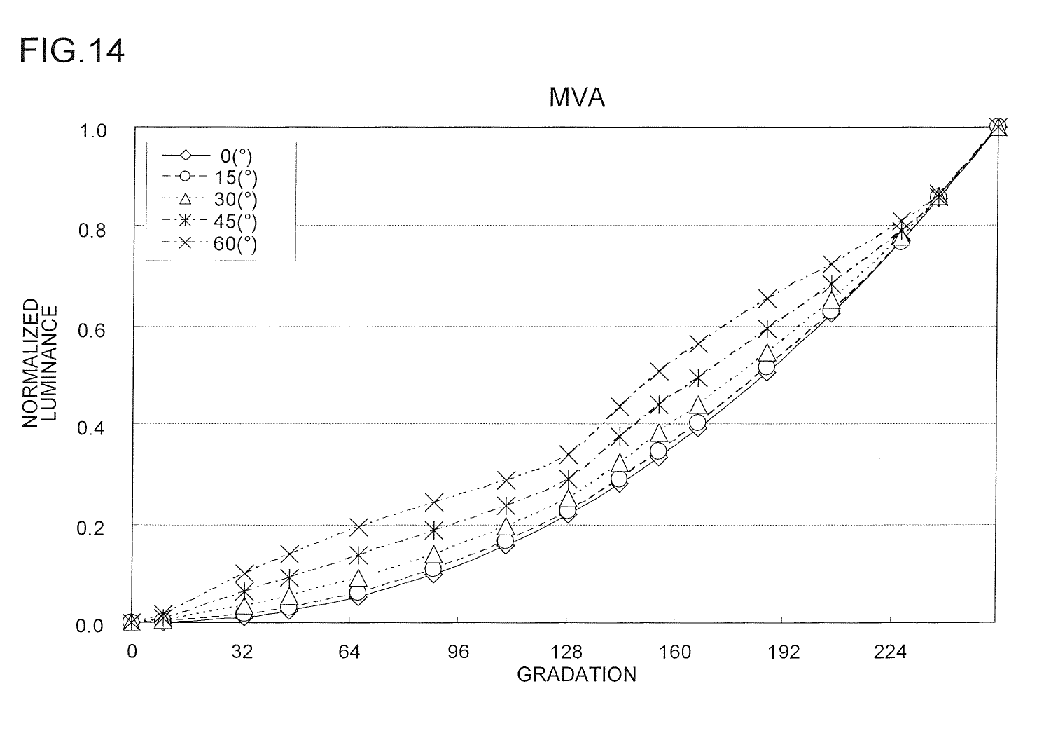

In the graphs in FIGS. 12 to 14, the vertical axis represents normalized luminance and the horizontal axis represents gradation. For each characteristics curve corresponding to a different viewing angle, characteristics in frontal view have been adjusted such that γ=2.2. Typically, the more the characteristics curve in oblique viewing overlaps the characteristics curve in frontal viewing, the less the perceived change in viewing angle. From this perspective, as shown in FIG. 14, with the liquid crystal display panel having MVA liquid crystal, the characteristics curves corresponding to different viewing angles do not overlap the characteristics curve in frontal viewing; thus, oblique viewing and frontal viewing produce evidently different appearances. For example, what appears solid black in frontal viewing appears whitish or rather gray in oblique viewing.

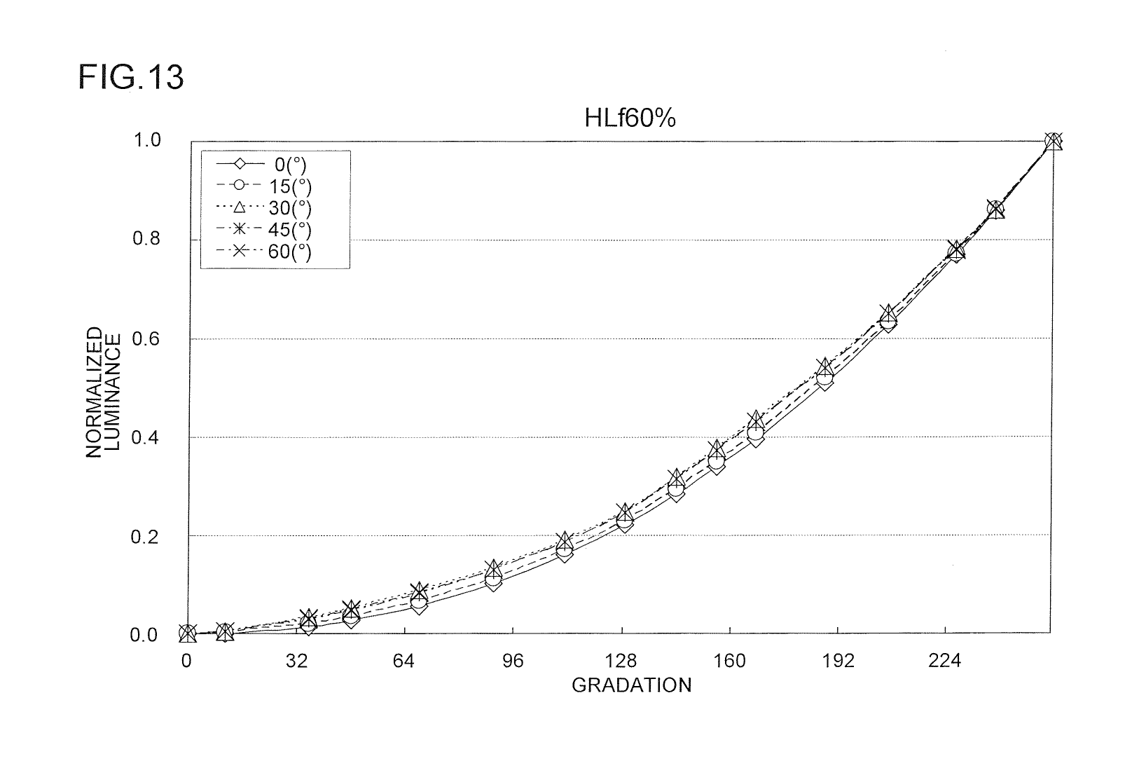

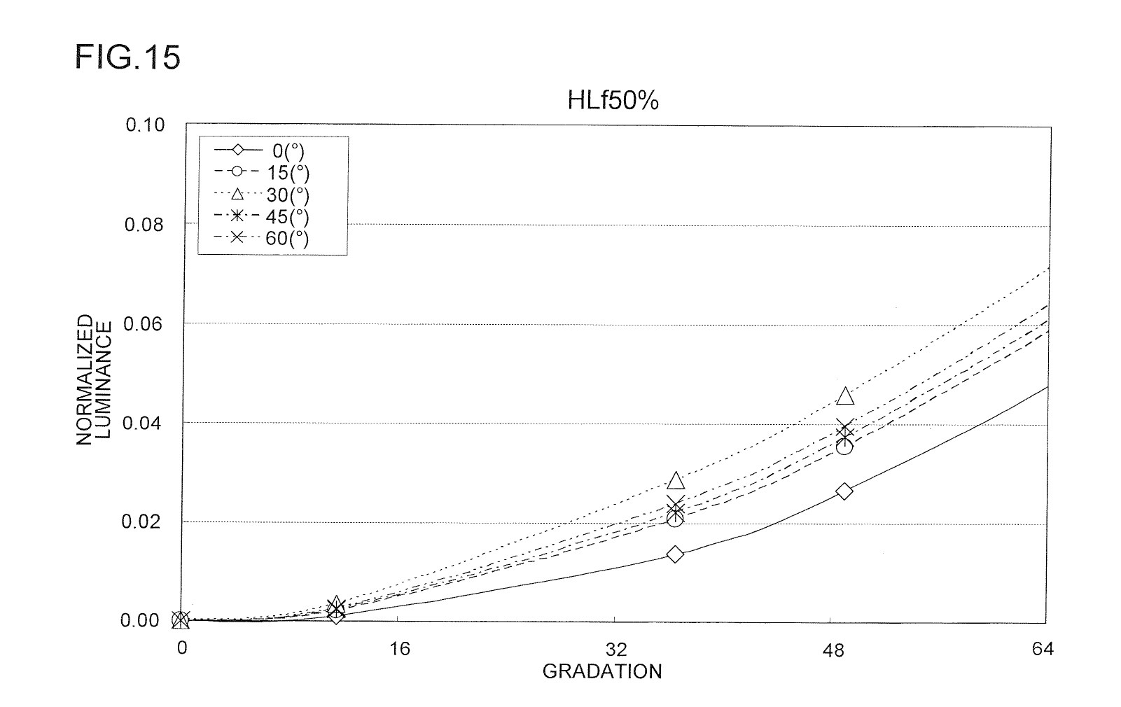

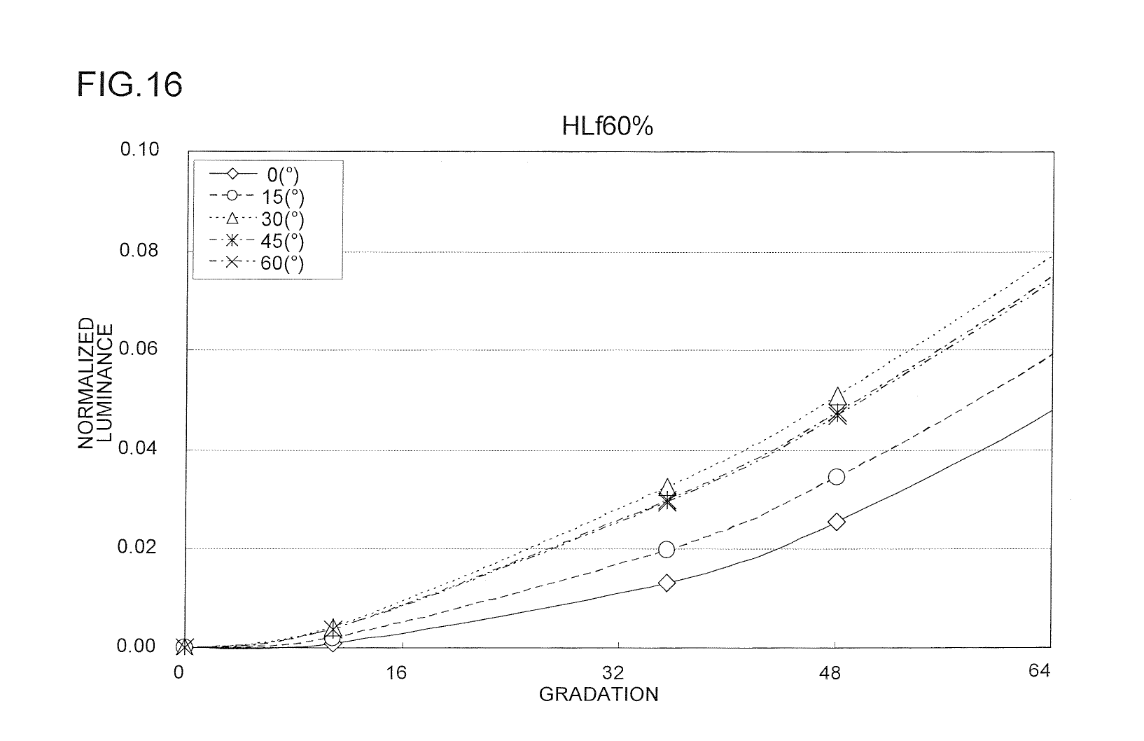

By contrast, with the liquid crystal display panels fitted with light emission angle adjusting sheets 11 with aperture ratios HLf of 50% and 60%, as shown in FIGS. 12 and 13, the characteristics curves corresponding to different viewing angles overlap the characteristics curve in frontal viewing, indicating a comparatively small change in viewing angle. However, a comparison of characteristics between aperture ratios HLf of 50% and 60% in a low-gradation range (gradation values 0 to 64) reveals that, as shown in FIG. 15 corresponding to an aperture ratio HLf of 50% and FIG. 16 corresponding to an aperture ratio HLf of 60%, with an aperture ratio HLf of 50%, the characteristics in oblique viewing are closer to those in frontal viewing, and hence the change in viewing angle is smaller, than with an aperture ratio HLf of 60%.

That is, adopting an aperture ratio HLf of 50% or more with a view to solving the above mentioned problem (the difference in appearance between oblique viewing and frontal viewing) does not achieve sufficient luminance diffusion, and thus does not improve viewing angle characteristics (perceived change in viewing angle).

In contrast to the comparative examples discussed above, light emission angle adjusting sheets 11 in which regions RG (RGn and RGw) with different aperture ratios HL (HLn and HLw) are arranged alternately perform as follows.

As shown in FIGS. 5 and 6, first of all, the luminance at a viewing angle of 0 (°) is about the same between a light emission angle adjusting sheet 11 in which regions RGf with the same aperture ratio HLf are arranged and a light emission angle adjusting sheet 11 in which regions RG (RGn and RGw) with different aperture ratios HL (HLn and HLw) are arranged alternately.

More specifically, a comparison of a light emission angle adjusting sheet 11 in which regions RGf with an aperture ratio HLf of 50% alone are arranged, a light emission angle adjusting sheet 11 in which regions RGn with an aperture ratio HLn of 40% and regions RGw with an aperture ratio HLw of 60% are arranged alternately, and a light emission angle adjusting sheet 11 in which regions RGn with an aperture ratio HLn of 35% and regions RGw with an aperture ratio HLw of 65% are arranged alternately reveals that, at a viewing angle of 0 (°), the luminance of the light emerging from all the light emission angle adjusting sheets 11 is about the same.

This is because the average value of an aperture ratio HLn of 40% and an aperture ratio HLw of 60% and the average value of an aperture ratio HLn of 35% and an aperture ratio HLw of 65% are both 50%, which is equal to an aperture ratio HLf of 50%.

On the other hand, also in the range of viewing angles from 0 (°) to about |40 (°)|, as at a viewing angle of 0 (°), the luminance is about the same with an aperture ratio HLn of 40% and an aperture ratio HLw of 60%, with an aperture ratio HLn of 35% and an aperture ratio HLw of 65%, and with an aperture ratio HLf of 50%. This is because, with the viewing angle not so large, the amount of light reflected on the side surfaces 13S of the low-refractive-index material 13 and emerging through the high-refractive-index material exposed portions 22 is affected less by the aperture ratio HL.

More specifically, of the light reflected on the side surfaces 13S of the low-refractive-index material 13, the part corresponding to viewing angles in the range from 0 (°) to about |40 (°)|(that is, the light with angles of emergence of 0 (°) to |40 (°)| relative to the light emission angle adjusting sheet 11), even when the width Dn of the high-refractive-index material exposed portions 22 is narrow to a certain degree, is not reflected on the side surfaces 13S of the low-refractive-index material 13 sandwiching the high-refractive-index material exposed portions 22, but emerges through the high-refractive-index material exposed portions 22. Light incident on, at angles close to parallel to, one of the side surfaces 13S of the low-refractive-index material 13 sandwiching the high-refractive-index material exposed portions 22 (if this incident light is incident on the other side surface 13S, it is far from being parallel) is reflected, and emerges through the high-refractive-index material exposed portions 22.

Of course, with the high-refractive-index material exposed portions 22 having the width Dw greater than the width Dn, a larger proportion of light directly shines on them, and therefore the light corresponding to viewing angles from 0 (°) to about |40 (°)| is not reflected on the side surfaces 13S of the adjacent low-refractive-index material 13, or is first incident on, at angles close to parallel to, the side surfaces 13S and then reflected, so as to eventually emerge through the high-refractive-index material exposed portions 22.

However, luminance in the range of viewing angles from |45 (°)| to about |65 (°)| is affected by the aperture ratio HL (see the regions enclosed by broken lines in FIGS. 5 and 6). Specifically, luminance with an aperture ratio HLn of 40% and an aperture ratio HLw of 50%, and luminance with an aperture ratio HLn of 35% and an aperture ratio HLw of 65%, is lower than luminance with an aperture ratio HLf of 50%. This is because, while frontal luminance is directly proportional to the width of the high-refractive-index material and thus takes the average value between the aperture ratio HLn and the aperture ratio HLw, luminance characteristics at larger angles are affected more by the aperture ratio HLw.

For example, the luminance distribution in the range of viewing angles of about |45 (°)| to about |65 (°)| occurs as a result of the light reflected on the side surfaces 13S of the low-refractive-index material 13 emerging through the high-refractive-index material exposed portions 22 and thereby becoming light corresponding to viewing angles in the range of about |45 (°)| to about |65 (°)|. The reason is that, compared with the light distribution at large angles resulting from the width Dn, the light distribution at large angles resulting from the width Dw greatly reduces luminance because of the reduced proportion of the side surfaces 13S of the low-refractive-index material 13 in a unit length.

Thus, with the light emission angle adjusting sheet 11, owing to the mixed arrangement of regions RGn with an aperture ratio HLn of 40% and regions RGw with an aperture ratio HLw of 60% and the presence of high-refractive-index material exposed portions 22 with a comparatively small width Dn, it is possible to suppress light corresponding to comparatively large viewing angles. Consequently, a light emission angle adjusting sheet 11 in which regions RG (RGn and RGw) with different aperture ratios HL (HLn and HLw) are arranged alternately as shown in FIG. 4 improves luminance diffusion characteristics more than a light emission angle adjusting sheet 11 in which regions RGf with a single aperture ratio HLf are arranged alternately (see FIGS. 5 and 6).

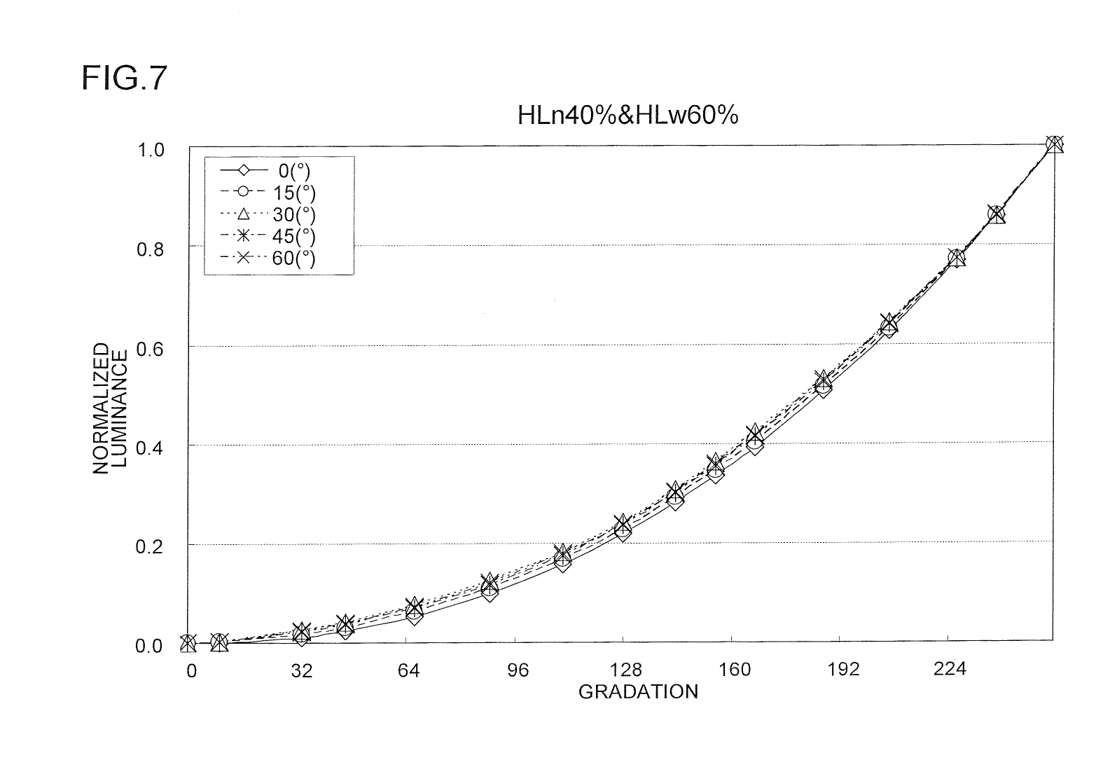

How small the change in viewing angle here is can be seen clearly from a graph, like the one shown in FIG. 7, corresponding to a light emission angle adjusting sheet 11 in which regions RGn with an aperture ratio HLn of 40% and regions RGw with an aperture ratio HLw of 60% are arranged alternately (that is, the characteristics curves corresponding to different viewing angles overlap the characteristics curve in frontal viewing, indicating a smaller change in viewing angle).

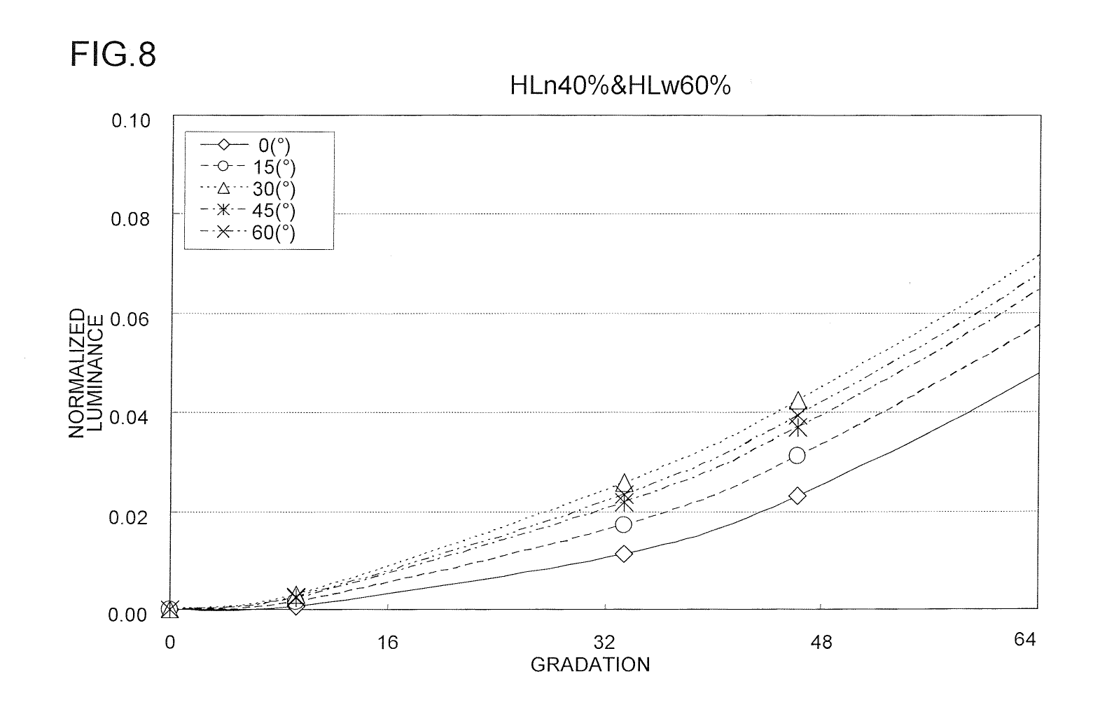

A comparison of FIG. 8, which shows gradation-luminance characteristics in a low-gradation range (gradation values of 0 to 64) corresponding to such a light emission angle adjusting sheet 11, with FIGS. 15 and 16 of comparative examples also reveals that the change in viewing angle is smaller in FIG. 8 than in FIGS. 15 and 16.

In view of the foregoing, preferably, on the light-output surface 11U of the light emission angle adjusting sheet 11, a plurality of low- and high-refractive-index material exposed portions 22 and 23 are spread, the low-refractive-index material exposed portions 23 have the same area, the high-refractive-index material exposed portions 22 have different areas, and a plurality of low-refractive-index material exposed portions 23 having the same area and a plurality of high-refractive-index material exposed portions 22 having different areas are arranged in a mixed fashion.

This structure gives a light emission angle adjusting sheet 11 in which, for example, regions RGn with an aperture ratio HLn of 40% and regions RGw with an aperture ratio HLw of 60% are arranged alternately. This light emission angle adjusting sheet 11 provides improved luminance diffusion as described above.

Preferably, as shown in FIG. 4, low-refractive-index material exposed portions 23 and high-refractive-index material exposed portions 22 are arranged alternately, there are two different areas that the high-refractive-index material exposed portions 22 have, and within the row of the high-refractive-index material exposed portions 22, high-refractive-index material exposed portions 22 having different areas are arranged alternately.

The reason is as follows. The distribution of the high-refractive-index material exposed portions 22 is then even over the light emission angle adjusting sheet 11, and as a result the luminance diffusion of the entire light emission angle adjusting sheet 11 is even; this surely improves the viewing angle characteristics of the liquid crystal display device 59 incorporating the light emission angle adjusting sheet 11. This, however, is not meant as any limitation.

For example, in a case where, compared with the pixel pitch of the liquid crystal display panel 39, the arrangement pitch of the high-refractive-index material exposed portions 22 is small (for example, in a case where, compared with the pixel pitch, the arrangement pitch of the high-refractive-index material exposed portions 22 is about one-half or less), then, within the row of the high-refractive-index material exposed portions 22, high-refractive-index material exposed portions 22 with different areas do not necessarily have to be arranged alternately.

Even if, in this way, high-refractive-index material exposed portions 22 of different areas are not arranged alternately, when, compared with the pixel pitch of the liquid crystal display panel 39, the arrangement pitch of the high-refractive-index material exposed portions 22 is small, differences in width among the high-refractive-index material exposed portions 22 are not visible as unevenness.

In addition to the regions RGn with an aperture ratio HLn and the regions RGw with an aperture ratio HLw, regions RG with an aperture ratio HL other than the aperture ratios HLn and HLw may also be included in the light emission angle adjusting sheet 11. That is, there may be three or more different areas that the high-refractive-index material exposed portions 22 have.

It is however preferable that, in the light emission angle adjusting sheet 11, the distribution of the high-refractive-index material exposed portions 22 having different areas be even (for example, in a case where different areas have the relationship “high-refractive-index material exposed portions 22a>refractive-index material exposed portions 22b>refractive-index material exposed portions 22c”, the high-refractive-index material exposed portions 22 are preferably arranged in recurring order of area). The reason is that this structure permits the entire light emission angle adjusting sheet 11 to surely provide improved luminance diffusion.

The low-refractive-index material 13, so that it can diffuse the light traveling from the light-input surface 11B of the light emission angle adjusting sheet 11, narrows monotonically toward the light-input surface 11B. Among many different shapes that narrow monotonically as desired here, preferable to be adopted in the low-refractive-index material 13 is the shape of a triangular prism that has flat side surfaces 13S, with no step or bend, opposite from each other and that defines, on a cross section crossing the prism axis direction, an isosceles triangle having the base surface 13B at the base and the side surfaces 13S at the sides.

The reason lies in the manufacturing method of the light emission angle adjusting sheet 11. For example, in a case where the light emission angle adjusting sheet 11 is manufactured by use of a die, the trough portions 12D of the sheet-form high-refractive-index material 12 reflect the shape of the die. In this case, when the low-refractive-index material 13 is in the shape of a triangular prism with an isosceles triangular cross section, a die having a corresponding shape can be produced by processing it with a cutting tool having a trapezoidal shape. If the side surfaces 13S of the low-refractive-index material 13 have a step or bend, the cutting tool needs to have high precision, and the produced die may suffer insufficient strength. Thus, in practical terms, it is preferable that the side surfaces 13S of the low-refractive-index material 13 be flat surfaces with no step or bend.

### Other Embodiments

It should be understood that the present invention is in no way limited by the embodiment presented above and may be carried out with many modifications made without departing from the spirit of the invention.

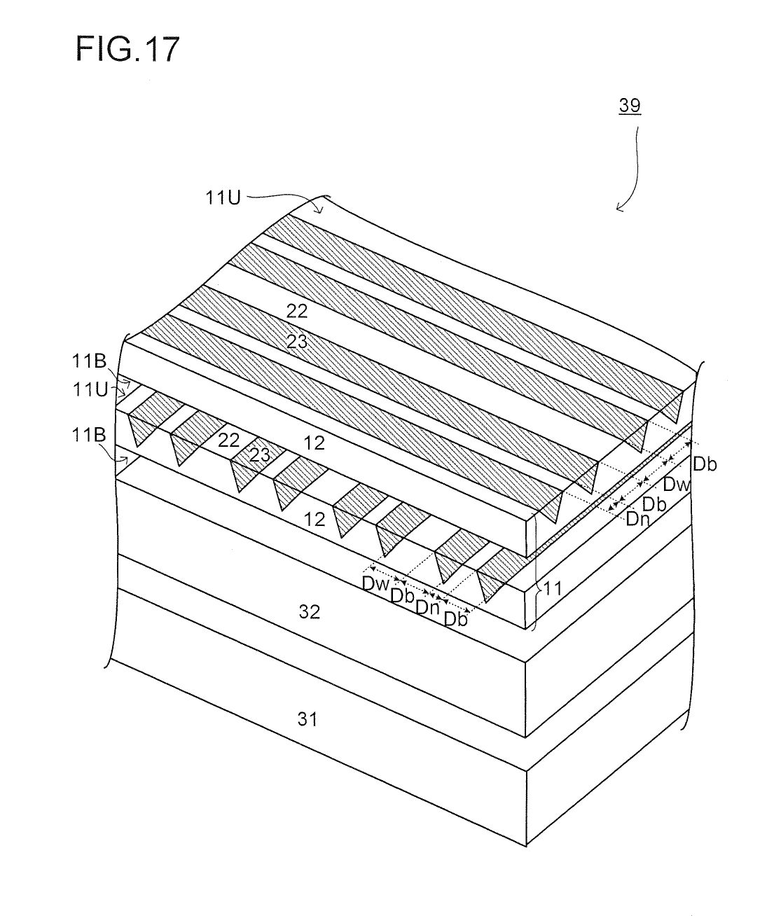

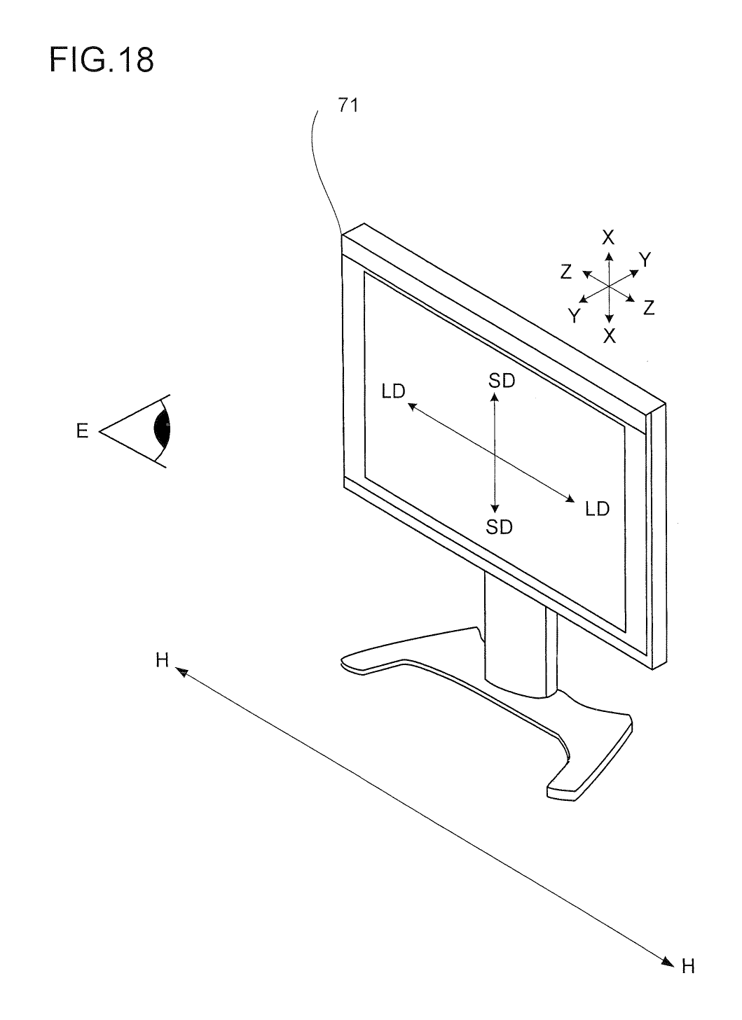

For example, although the above description deals with a case where the light emission angle adjusting sheet 11 having the low-refractive-index material 13 arranged in a row has a single-layer structure, the light emission angle adjusting sheet 11 may instead have a multiple-layer (for example, two-layer) structure. For example, as shown in an exploded perspective view in FIG. 17, a multiple-layer light emission angle adjusting sheet 11 may comprise a light emission angle adjusting sheet 11 in a first layer and a light emission angle adjusting sheet 11 in a second layer (a plurality of light emission angle adjusting sheets 11 stacked together may as a whole be called a light emission angle adjusting sheet 11).

In particular, it is then preferable that the extension direction of the low-refractive-index material exposed portions 23 in the light emission angle adjusting sheet 11 in the first layer and the extension direction of the low-refractive-index material exposed portions 23 in the light emission angle adjusting sheet 11 in the second layer cross each other (for example, perpendicularly).

With this structure, the light emerging from the light emission angle adjusting sheet 11 is diffused in two directions, namely in the arrangement direction of the low-refractive-index material 13 in the light emission angle adjusting sheet 11 in the first layer and in the arrangement direction of the low-refractive-index material 13 in the light emission angle adjusting sheet 11 in the second layer. This improves the luminance distribution characteristics of the light emerging from the light emission angle adjusting sheet 11 (and hence the liquid crystal display panel 39) in two directions that cross each other on the panel plane.

The direction in which the light emission angle adjusting sheet 11 diffuses depends on the direction in which the low-refractive-index material 13 is linear (in other words, the arrangement direction of the low-refractive-index material 13). Thus, when the liquid crystal display panel 39 in the liquid crystal display device 59 is arranged in a reference position with respect to the horizontal direction, there is a desired diffusion direction that suits how the viewer views.

For example, as shown in FIG. 18, suppose that a liquid crystal television 71 as one example of the liquid crystal display device 59 is placed with the longer-side direction LD (the first reference direction, aligned with the horizontal direction H) of the liquid crystal display panel 39 aligned with the horizontal direction H (this position of the liquid crystal television 71 is taken as the reference position). Then, the viewer's eye E is usually located largely straight in front of the liquid crystal display panel 39.

In such a case, it is preferable that the low-refractive-index material exposed portions 23 in the light emission angle adjusting sheet 11 be linear, and that the direction in which they are linear coincide with the shorter-side direction SD (the second reference direction) of the liquid crystal display panel 39 which crosses the longer-side direction LD. With this arrangement, the light from the liquid crystal television 71 having passed through the light emission angle adjusting sheet 11 is surely diffused across a 120 (°) range of viewing angles in the horizontal direction, which covers the typical viewing position for the liquid crystal television 71, that is, across the range of viewing angles of ±60 (°) in FIGS. 5 and 6.

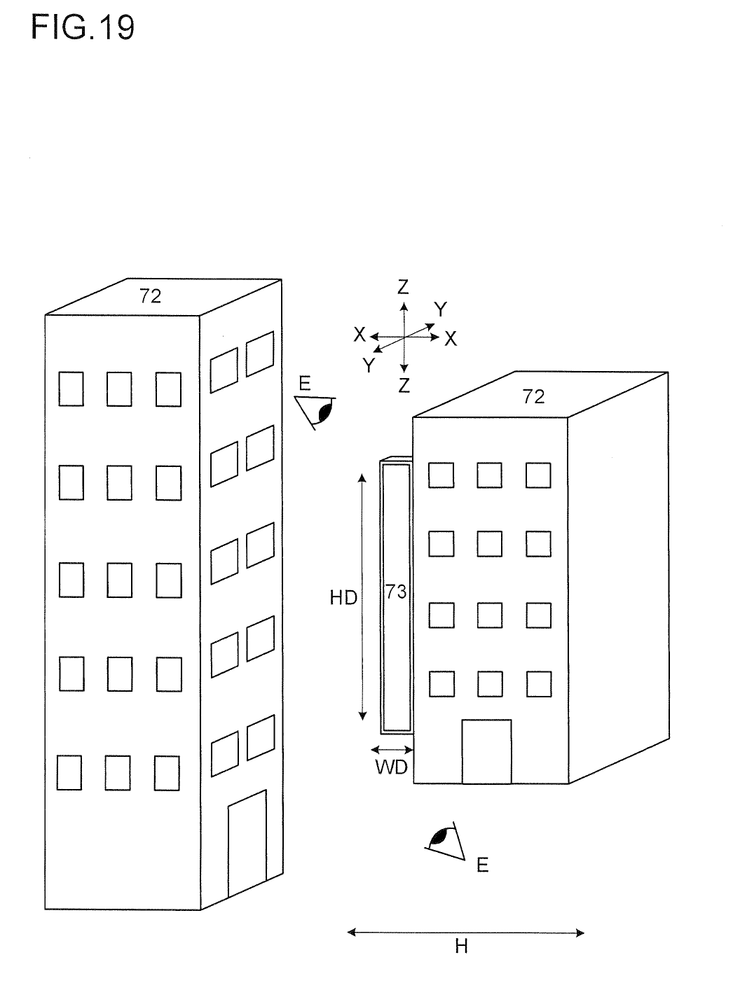

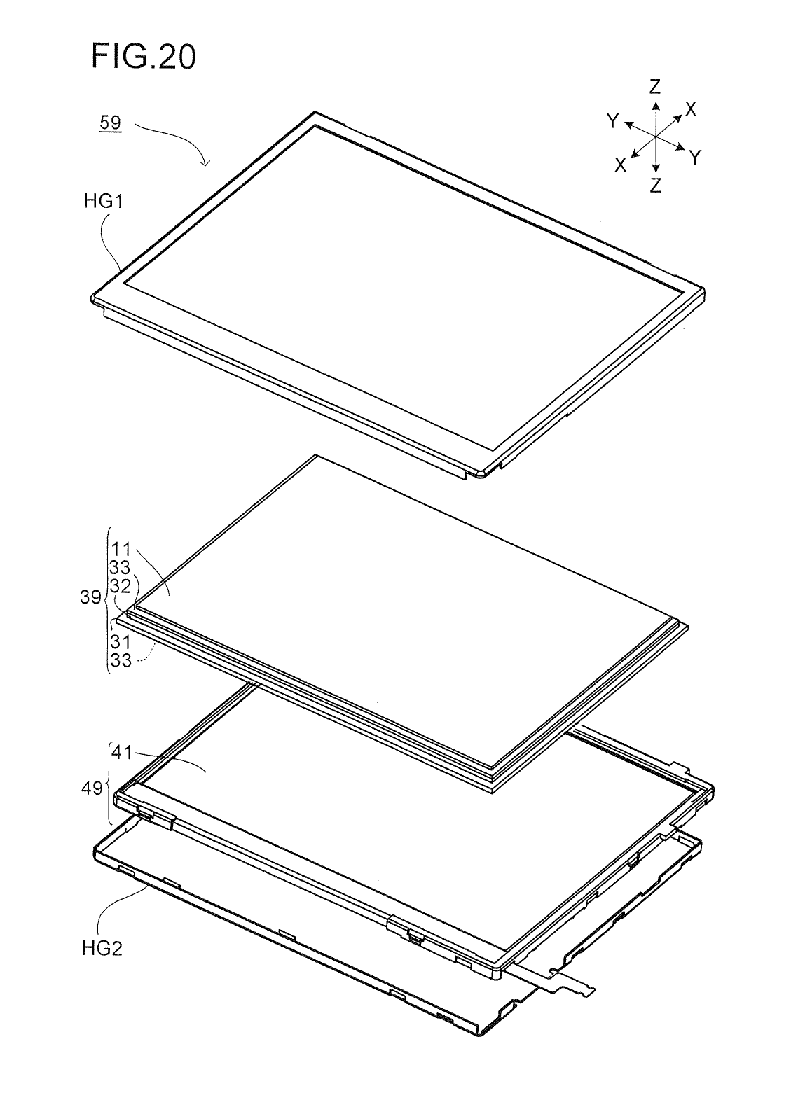

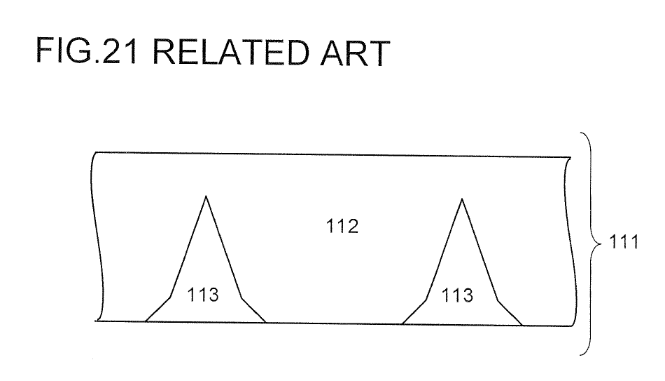

The liquid crystal display device 59 may be applied in devices other than liquid crystal televisions. For example, as shown in FIG. 19, the liquid crystal display device 59 may be adopted in an advertising display 73 on a building 72 (the use of a system employing such a display 73 is often called digital signage).

Suppose that, as a result of such a vertically elongate display 73 being installed on a wall surface of a building 72, the display 73 extends in the vertical direction crossing the horizontal direction H (this position of the display 73 is taken as the reference position). Then, while the eye E of a viewer on the ground looks up to the display 73, the eye E of a viewer on an upper floor in another, opposite building looks down to the display 73.

In such a case, it is preferable that, in the light emission angle adjusting sheet 11, the low-refractive-index material exposed portions 23 be linear, and that the direction in which they are linear coincide with the width direction WD (the first reference direction) of the liquid crystal display panel 39 which crosses the longitudinal direction HD (the second reference direction) of the display 73. With this arrangement, the light from the display 73 having passes through the light emission angle adjusting sheet 11 is diffused toward both the viewer on the ground and the viewer in an upper floor in the other building 72.

Although the above description deals with cases where, as one example of the low-refractive-index material 13, a transparent resin is used, this is not meant to be any limitation. For example, the low-refractive-index material 13 may contain a material (light-absorbing material), such as carbon black or titanium black, that absorbs light such as visible light. This increases flexibility in the choice of the resin for the low-refractive-index material 13.

The light emission angle adjusting sheet 11 may be laid with, on the light-output surface 11U, a surface treatment film (such as an AG (anti-glare) film or an AGLR (anti-glare low-reflection) film). This helps reduce reflection of sunlight or the like on the light emission angle adjusting sheet 11 (and hence the liquid crystal display panel 39).

### LIST OF REFERENCE SIGNS

11 light emission angle adjusting sheet
11U light-output surface of a light emission angle adjusting sheet
11B light-input surface of a light emission angle adjusting sheet
12 high-refractive-index material
12U irregular surface of a high-refractive-index material
12D trough portion
12F flat portion
12i inner wall of a trough portion
12B flat surface of a high-refractive-index material
13 low-refractive-index material
13B base surface of a low-refractive-index material
13S side surface of a low-refractive-index material
22 high-refractive-index material exposed portions
23 low-refractive-index material exposed portions
AR[H] area of a high-refractive-index material exposed portions
AR[H] area of a low-refractive-index material exposed portions
RG region
HR aperture ratio
D width
31 active matrix substrate
32 counter substrate
33 polarizing film
39 liquid crystal display panel (display panel)
41 stack of optical sheets
49 backlight unit (illuminating device)
59 liquid crystal display device (display device)
71 liquid crystal television (display device)
73 display (display device)
HD horizontal direction
LD longer-side direction of a liquid crystal display panel (first reference direction)
SD shorter-side direction of a liquid crystal display panel (second reference direction)
HD longitudinal direction of a display (second reference direction)
WD width direction of a display (first reference direction)

1. A light emission angle adjusting sheet comprising a light-input surface and a light-output surface through which light having passed through the light-input surface is let out, wherein
the sheet comprises a low-refractive-index material and a high-refractive-index material having different refractive indices,
on the light-output surface, there are spread a plurality of low-refractive-index material exposed portions, where the low-refractive-index material is exposed, and a plurality of high-refractive-index material exposed portions, where the high-refractive-index material is exposed,
the plurality of low-refractive-index material exposed portions, which have a same area, and the plurality of high-refractive-index material exposed portions, which have different areas, are arranged in a mixed fashion, and
the low-refractive-index material has a shape that monotonically narrows toward the light-input surface.

2. The light emission angle adjusting sheet according to claim 1, wherein
the low-refractive-index material is triangular-prism-shaped, with one angle of a triangular shape pointing to the light-input surface and other two angles pointing to the light-output surface, and defines, on a cross section crossing a prism axis direction, an isosceles triangle having the light-input surface-side one angle as a vertical angle and the other two angles as base angles.

3. The light emission angle adjusting sheet according to claim 1, wherein
the low-refractive-index material exposed portions and the high-refractive-index material exposed portions are arranged alternately,
there are two or more different areas that the high-refractive-index material exposed portions have, and
among the high-refractive-index material exposed portions, high-refractive-index material exposed portions having different areas are arranged alternately.

4. The light emission angle adjusting sheet according to claim 1, wherein
the low-refractive-index material comprises a transparent resin or a transparent resin containing a light-absorbing material.

5. The light emission angle adjusting sheet according to claim 1, wherein
the sheet has a two-layer structure, and
an extension direction of the low-refractive-index material exposed portions in a first layer and an extension direction of the low-refractive-index material exposed portions in a second layer cross each other.

6. The light emission angle adjusting sheet according to claim 1, wherein
the light-output surface is laid with a surface treatment film.

7. A display panel having the light emission angle adjusting sheet according to claim 1 fitted on a display surface.

8. A display device comprising:
the display panel according to claim 7; and
an illuminating device which supplies light to the display panel.

9. The display device according to claim 8, wherein
when
a reference position of the display panel is determined with respect to a horizontal direction, and
on a plane of the display panel arranged in the reference position, a first reference direction is defined to run in a same direction as the horizontal direction and a second reference direction is defined to cross the first reference direction,
then
the low-refractive-index material exposed portions are linear, and a direction in which the low-refractive-index material exposed portions are linear coincides with the first or second reference direction.

10. A method of manufacturing the light emission angle adjusting sheet according to claim 1, wherein
a die processed to have a shape corresponding to a shape of the low-refractive-index material is used in an oxidation process involving anodic oxidation.
